(19) United States
(12) Patent Application Publication
(10) Pub. No.: US 2026/0149295 A1
(43) Pub. Date: May 28, 2026

(54) MULTIFUNCTIONAL ON-BOARD CHARGER

(71) Applicant: Shenzhen Yishunxing Technology Co., Ltd., Shenzhen (CN)

(72) Inventor: Haosheng Lin, Shenzhen (CN)

(21) Appl. No.: 19/058,054

(22) Filed: Feb. 20, 2025

(30) Foreign Application Priority Data
Nov. 25, 2024 (CN) 202422872328.4

(51) Int. Cl. H02J 7/00; F21V 33/00; F21Y 115/10

(52) U.S. Cl. CPC H02J 7/70; F21V 33/0004; F21Y 2115/10

(57) ABSTRACT

The present disclosure discloses a multifunctional on-board charger, including an accommodation cavity and an accommodation slot. The accommodation cavity accommodates a retractable charging cable assembly. The accommodation slot is used to accommodate a liquid cartridge assembly which includes an outer cartridge and an inner cartridge. The outer cartridge is provided with a first through hole directly communicating with the air. The liquid cartridge assembly can accommodate an aromatherapy liquid. Therefore, the on-board charger achieves more functions under the hardware condition of a small size, thereby solving the technical problems that when an existing on-board charger is plugged in a position of a cigarette lighter to perform charging, other functions for consumers cannot be achieved at the same time, and multiple on-board electrical appliances need to be prepared and repeatedly plugged and unplugged, resulting in an unsatisfactory user experience.

### CROSS REFERENCE TO RELATED APPLICATIONS

The present application claims the benefit of Chinese Patent Application No. 202422872328.4 filed on Nov. 25, 2024, the contents of which are incorporated herein by reference in their entirety.

### TECHNICAL FIELD

The present disclosure relates to the technical field of on-board chargers, in particular to a multifunctional on-board charger.

### BACKGROUND

On-board chargers are usually powered by vehicle batteries (12V for cars and 24V for trucks), and are widely used in the field of lithium battery charging for various portable and handheld apparatuses. The on-board charger uses a cigarette lighter of a vehicle as a power socket, to directly charge a mobile phone. Only an overload protection circuit needs to be provided in the on-board charger due to a low voltage provided by the vehicle. A fuse tube is provided at a front end of a socket of the on-board charger. When a current exceeds a tolerable range of the overload protection circuit, a fuse blows immediately, so as to provide protection. An existing on-board charger is limited by a small interior space of a vehicle and a single socket. When the on-board charger is plugged in a position of a cigarette lighter to perform charging, other functions for consumers cannot be achieved at the same time, and multiple on-board electrical appliances need to be prepared and repeatedly plugged and unplugged, resulting in poor user experience.

### SUMMARY

In order to overcome the shortcomings and defects in the prior art, the present disclosure provides a multifunctional on-board charger which solves the technical problems that when an existing on-board charger is plugged in a position of a cigarette lighter to perform charging, other functions for consumers cannot be achieved at the same time, and multiple on-board electrical appliances need to be provided and repeatedly plugged and unplugged, resulting in an unsatisfactory user experience.

The present disclosure achieves the above objective by means of the following technical solutions: a multifunctional on-board charger, including a plug assembly and a main body. The main body is provided with an accommodation cavity. The accommodation cavity accommodates a retractable charging cable assembly. The main body is provided with an accommodation slot. The accommodation slot is used to accommodate a liquid cartridge assembly. The liquid cartridge assembly includes an outer cartridge and an inner cartridge. The outer cartridge is provided with a first through hole directly communicating with the air.

Preferably, the plug assembly and the main body are rotatably connected to each other by means of a rotating shaft. The liquid cartridge assembly includes a cartridge cover. A fifth through hole is provided in the cartridge cover.

Preferably, the cartridge cover and the inner cartridge are in knob-type threaded fit.

Preferably, the outer cartridge includes a lapping portion. The lapping portion and a cavity body wall of the main body are assembled and fixed.

Preferably, a second through hole is provided in the lapping portion. The second through hole is used to allow a charging cable of the retractable charging cable assembly to pass therethrough.

Preferably, an LED atmosphere lamp is further included. A third through hole is provided in the lapping portion. The third through hole is used to allow light of the LED atmosphere lamp to pass therethrough.

Preferably, a switch button is further included. A fourth through hole is provided in the lapping portion. The fourth through hole is used to allow the switch button to pass therethrough, and then to be exposed outside the main body.

Preferably, the plug assembly includes a charging head main board and a handle housing. The plug assembly is used to be inserted into an on-board power hole, so as to enable the multifunctional on-board charger to be powered.

Preferably, a liquid cartridge main board is further included. The liquid cartridge main board is inserted into the charging head main board. The liquid cartridge main board is used to atomize a liquid in the inner cartridge of the liquid cartridge assembly.

Preferably, an atmosphere lamp main board is further included. The atmosphere lamp main board is inserted into the charging head main board. The atmosphere lamp main board is used to control switching of the LED atmosphere lamp.

Compared with the prior art, the present disclosure produces the following beneficial effects:
The present disclosure discloses a multifunctional on-board charger, including a plug assembly and a main body, wherein the plug assembly and the main body are rotatably connected to each other by means of a rotating shaft. The main body is provided with an accommodation cavity. The accommodation cavity accommodates a retractable charging cable assembly. The main body is provided with an accommodation slot. The accommodation slot is used to accommodate a liquid cartridge assembly. The liquid cartridge assembly includes an outer cartridge and an inner cartridge. The outer cartridge is provided with a first through hole directly communicating with the air. Both the retractable charging cable assembly and the liquid cartridge assembly are accommodated in the main body of the multifunctional on-board charger. The liquid cartridge assembly can accommodate an aromatherapy liquid. An LED atmosphere lamp assembly can be further provided in an integrated manner. Therefore, the on-board charger achieves more functions under the hardware condition of a small size, thereby solving the technical problems in which when an existing on-board charger is plugged in a position of a cigarette lighter to perform charging, other functions for consumers cannot be achieved at the same time, and multiple on-board electrical appliances need to be prepared and repeatedly plugged and unplugged, resulting in a poor user experience. The on-board charger is small and multi-functional, such that a user can easily perform function selection and switching, and has a good use experience.

### BRIEF DESCRIPTION OF DRAWINGS

In order to more clearly illustrate the technical solutions in the embodiments of the present disclosure or in the prior art, the accompanying drawings required for use in the description of the embodiments or the prior art are briefly introduced below.

FIG. 1 shows a front view of a multifunctional on-board charger of the present disclosure.

FIG. 2 shows a top view of the multifunctional on-board charger of the present disclosure.

FIG. 3 shows an exploded view of the multifunctional on-board charger of the present disclosure.

Reference Signs: 1—plug assembly; 11—charging head main board; 12—handle housing; 2—main body; 3—rotating shaft; 4—retractable charging cable assembly; 5—liquid cartridge assembly; 51—outer cartridge; 511—first through hole; 512—lapping portion; 5121—second through hole; 5122—third through hole; 5123—fourth through hole; 52—inner cartridge; 53—cartridge cover; 531—fifth through hole; 54—liquid cartridge main board; 6—LED atmosphere lamp; 61—atmosphere lamp main board; and 7—switch button.

### DETAILED DESCRIPTION

The present disclosure is further illustrated below with reference to the accompanying drawings and specific embodiments, but the described embodiments are only part of the embodiments of the present disclosure, not all of the embodiments.

On the basis of the embodiments of the present disclosure, all other embodiments obtained by a person of ordinary skill in the art without making any exercise of inventive effort fall within the scope of protection of the present disclosure.

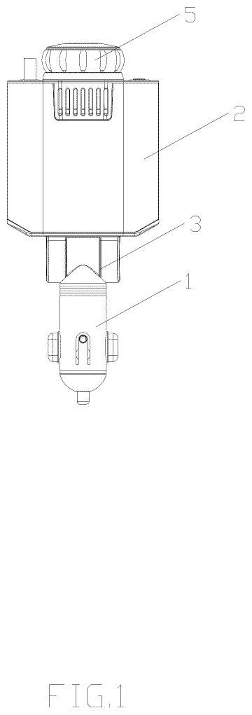

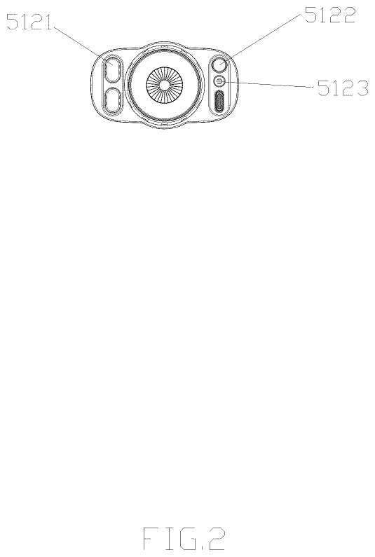

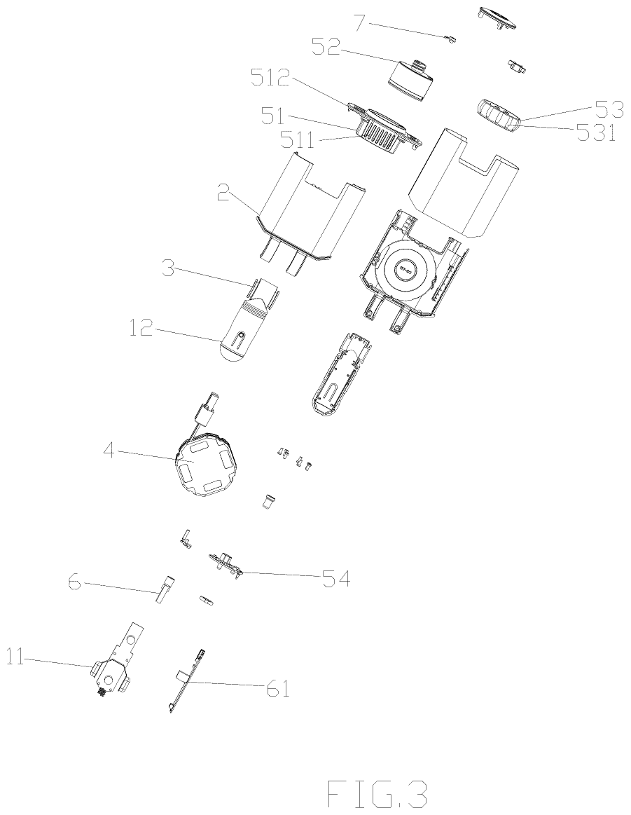

Referring to FIG. 1 to FIG. 3, a multifunctional on-board charger includes a plug assembly 1 and a main body 2. The main body 2 is provided with an accommodation cavity. The accommodation cavity accommodates a retractable charging cable assembly 4. The main body 2 is provided with an accommodation slot. The accommodation slot is used to accommodate a liquid cartridge assembly 5. The liquid cartridge assembly 5 includes an outer cartridge 51, an inner cartridge 52, a cartridge cover 53, and a liquid cartridge main board 54. The inner cartridge 52 is used to accommodate an aromatherapy liquid. The cartridge cover 53 and the inner cartridge 52 are in knob-type threaded fit. A fifth through hole 531 is provided in the cartridge cover 53. The liquid cartridge main board 54 is inserted into a charging head main board 11. The liquid cartridge main board 54 is used to atomize a liquid in the inner cartridge 52 of the liquid cartridge assembly 5. The outer cartridge 51 is provided with a strip-shaped first through hole 511 directly communicating with the air and a lapping portion 512 disposed at two ends of the outer cartridge 51. The lapping portion 512 and a cavity body wall of the main body 2 are assembled and fixed. A second through hole 5121 is provided in the lapping portion 512. The second through hole 5121 is used to allow a charging cable of the retractable charging cable assembly 4 to pass therethrough. The main body 2 accommodates an LED atmosphere lamp 6 and an atmosphere lamp main board 61. The LED atmosphere lamp 6 can be a starry sky lamp. The atmosphere lamp main board 61 is inserted into the charging head main board 11. The atmosphere lamp main board 61 is used to control switching of the LED atmosphere lamp 6. A third through hole 5122 is provided in the lapping portion 512. The third through hole 5122 is used to allow light of the LED atmosphere lamp 6 to pass therethrough. In addition, the first through hole 511 can be used to allow the light of the LED atmosphere lamp 6 to escape, thereby improving the use effect of the atmosphere lamp. The multifunctional on-board charger includes a switch button 7. A fourth through hole 5123 is provided in the lapping portion 512. The fourth through hole 5123 is used to allow the switch button 7 to pass therethrough, and then be exposed outside the main body 2, and is used to control on and off of the entire multifunctional on-board charger.

Furthermore, the plug assembly 1 and the main body 2 are rotatably connected to each other by means of a rotating shaft 3. The plug assembly 1 includes the charging head main board 11 and a handle housing 12. The plug assembly 1 is used to be inserted into an on-board power hole, so as to enable the multifunctional on-board charger to be powered.

The above examples are only specific embodiments of the present disclosure. Obviously, the present disclosure is not limited to the above embodiments, and many similar variations can also be made. All variations that can be directly derived from or associated with the disclosure of the present disclosure by a person of ordinary skill in the art shall be considered to be within the scope of protection of the present disclosure.

What is claimed is:

1. A multifunctional on-board charger, comprising a plug assembly (1) and a main body (2), wherein the main body (2) is provided with an accommodation cavity, the accommodation cavity accommodates a retractable charging cable assembly (4), the main body (2) is provided with an accommodation slot, the accommodation slot is used to accommodate a liquid cartridge assembly (5), the liquid cartridge assembly (5) comprises an outer cartridge (51) and an inner cartridge (52), and the outer cartridge (51) is provided with a first through hole (511) directly communicating with the air.

2. The multifunctional on-board charger of claim 1, wherein the plug assembly (1) and the main body (2) are rotatably connected to each other by means of a rotating shaft (3), the liquid cartridge assembly (5) comprises a cartridge cover (53), and a fifth through hole (531) is provided in the cartridge cover (53).

3. The multifunctional on-board charger of claim 2, wherein the cartridge cover (53) and the inner cartridge (52) are in knob-type threaded fit.

4. The multifunctional on-board charger of claim 1, wherein the outer cartridge (51) comprises a lapping portion (512), and the lapping portion (512) and a cavity body wall of the main body (2) are assembled and fixed.

5. The multifunctional on-board charger of claim 4, wherein a second through hole (5121) is provided in the lapping portion (512), and the second through hole (5121) is used to allow a charging cable of the retractable charging cable assembly (4) to pass therethrough.

6. The multifunctional on-board charger of claim 4, further comprising an LED atmosphere lamp (6), wherein a third through hole (5122) is provided in the lapping portion (512), and the third through hole (5122) is used to allow light of the LED atmosphere lamp (6) to pass therethrough.

7. The multifunctional on-board charger of claim 4, further comprising a switch button (7), wherein a fourth through hole (5123) is provided in the lapping portion (512), and the fourth through hole (5123) is used to allow the switch button (7) to pass therethrough, and then be exposed outside the main body (2).

8. The multifunctional on-board charger of claim 6, wherein the plug assembly (1) comprises a charging head main board (11) and a handle housing (12), and the plug assembly (1) is used to be inserted into an on-board power hole, so as to enable the multifunctional on-board charger to be powered.

9. The multifunctional on-board charger of claim 8, further comprising a liquid cartridge main board (54), wherein the liquid cartridge main board (54) is inserted into the charging head main board (11), and the liquid cartridge main board (54) is used to atomize a liquid in the inner cartridge (52) of the liquid cartridge assembly (5).

10. The multifunctional on-board charger of claim 8, further comprising an atmosphere lamp main board (61), wherein the atmosphere lamp main board (61) is inserted into the charging head main board (11), and the atmosphere lamp main board (61) is used to control switching of the LED atmosphere lamp (6).
